(19) United States
(12) Patent Application Publication
(10) Pub. No.: US 2010/0133309 A1
(43) Pub. Date: Jun. 3, 2010

(54) BASKET

(76) Inventor: SHENG-KAI LEE, Taichung (TW)

Correspondence Address: Dr. BANGER SHIA;Patent Office of Bang Shia, 102 Lindencrest Ct, Sugar Land, TX, 77479-5201, US

(21) Appl. No.: 12/325,859

(22) Filed: Dec. 1, 2008

(51) Int. Cl. B62J 7/06; B62J 7/00

(52) U.S. Cl. 224/420; 224/433

(57) ABSTRACT

A basket includes a basket body and two wings pivoted on two opposite sides of the basket body respectively. The basket body has an upper opening and defines an inner space therein. The wings are able to wiggle with respect to the sides, wherein a length between a fixed end and a free end of each wing is smaller than a height of the basket body, and a sum of the lengths is a little longer than a breadth of the opening. On the free ends of the wings are disposed fasten members corresponding to and being able to connect with each other, so that the two wings bridge the opening and cover the inner space.

### FIELD OF THE INVENTION

The present invention relates to a basket.

### DESCRIPTION OF THE PRIOR ART

Conventional basket may be installed on a bicycle. Commonly the basket should have an upper opening, yet no cover is provided thereon. Hence, the goods placed therein may jump out of the basket when the bicycle coming up against a jolt, which causes the users much trouble. Some users may use additional belts to fasten the goods, yet it is still not so convenient.

Some baskets are provided with a resilient arm to hold the goods to be securely placed therein. However, the length of the arm is limited by the height of the basket so that the arm cannot provide sufficient coverage of protection. Besides, the arm is used to directly clamp the goods and may cause unnecessary damage to it.

### SUMMARY OF THE INVENTION

The main object of the present invention is to provide a basket which can completely cover an upper opening thereof.

Another object of the present invention is to provide a portable basket.

To achieve the above object, the present invention provides a basket. The basket includes a basket and two wings pivoted on two opposite sides of the basket body respectively. The basket body has an upper opening and defines an inner space therein. The wings are able to wiggle with respect to the sides, wherein a length between a fixed end and a free end of each wing is smaller than a height of the basket body, and a sum of the lengths is a little longer than a breadth of the opening. On the free ends of the wings are disposed fasten members corresponding to and being able to connect with each other, so that the two wings bridge the opening and cover the inner space.

In the present invention, the basket further includes a connecting member for detachably connecting to a bicycle.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a diagram showing a first service condition of a basket of the present invention;

FIG. 2 is a diagram showing a second service condition of a basket of the present invention;

FIG. 3 is a diagram showing a basket of the present invention connecting to a handle of a bicycle;

FIG. 4 is a bottom view of a basket of the present invention;

FIG. 5 is a diagram showing a basket of the present invention connecting to a luggage carrier of a bicycle;

FIG. 5A is a diagram showing a fastening belt of the basket connecting to a seat tube of a bicycle.

### DETAILED DESCRIPTION OF THE PREFERRED EMBODIMENTS

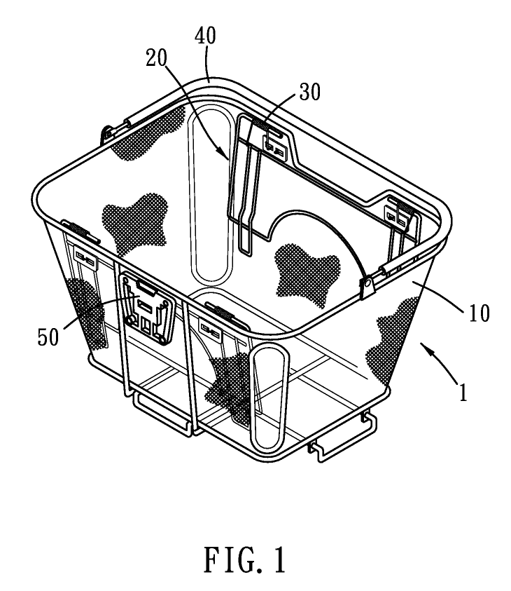

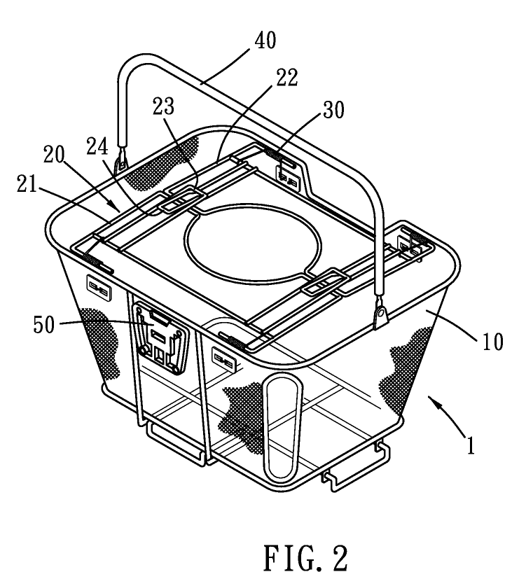

Please refer to FIG. 1-2. A basket 1 includes a basket body 10 and two wings 20. The basket body 10 has an upper opening and defines an inner space for users to place goods therein. The wings 20 consists of a first wing 21 and a second wing 22, which are pivoted on two opposite sides of the basket body 10 respectively and are able to wiggle with respect to the sides. Both the first wing 21 and the second wing 22 have a free end and a fixed end respectively. There are fasten members disposed on the free ends of the first and second wings 21, 22. The fasten member of the first wing 21 includes two first rectangular frames 23, and the fasten member off the second wing 22 includes two first rectangular frames 24 corresponding to the first rectangular frames 23. the lengths between the fixed end and the free end of the first and second wings 21, 22 are smaller than a height of the basket body 10. The sum of the afore-mentioned lengths is a little longer than a breadth of the opening. In addition, a breadth of the first rectangular frame 23 is bigger than that of the second rectangular frame 24, and the second rectangular frame 24 is able to thrust through a hole defined by the first rectangular frame 23 so that the two wings bridge the opening and cover the inner space.

In the present embodiment, the two wings 20 can connect to each other by means of the connection of the first and second rectangular frame 23, 24. Yet there are still other means can be used to connect the two wings 20, such as fastening belts, Velcro patches, tenon sets, buckles and the likes, whereby the two wings 20 bridge the opening.

Moreover, the basket 1 further includes a plurality of torsion springs 30 disposed between the basket body 10 and the wings 20 respectively. One end of each torsion spring 30 abuts the basket body 10, and another end of each torsion spring 30 abuts the selected wing 20, whereby urging the wings 20 wiggle toward a bottom of the basket body 10.

In the present invention, the torsion springs 30 could also apply torque on the wings 20 when the wings 20 are in use, such that the wings 20 can fasten to each other securely. And when the wings 20 are not in use, the torsion spring 30 could urge the wings 20 to stay close to the sides of the basket body 10. However, the torsion spring 30 can also be abandoned as desired. Still, the wings 20 can fasten to each other or stay close to the sides of the basket body 10 on the strength of the gravity.

In addition, the free ends of the wings 20 are formed in an arc shape. The free ends of both wings 20 define a circular hole when the connecting members connect with each other, such that elongated goods with its length larger than the height of the basket body 10 can be placed in the basket 1 or a pet can pop its head out of the circular hole while being placed in the basket 1.

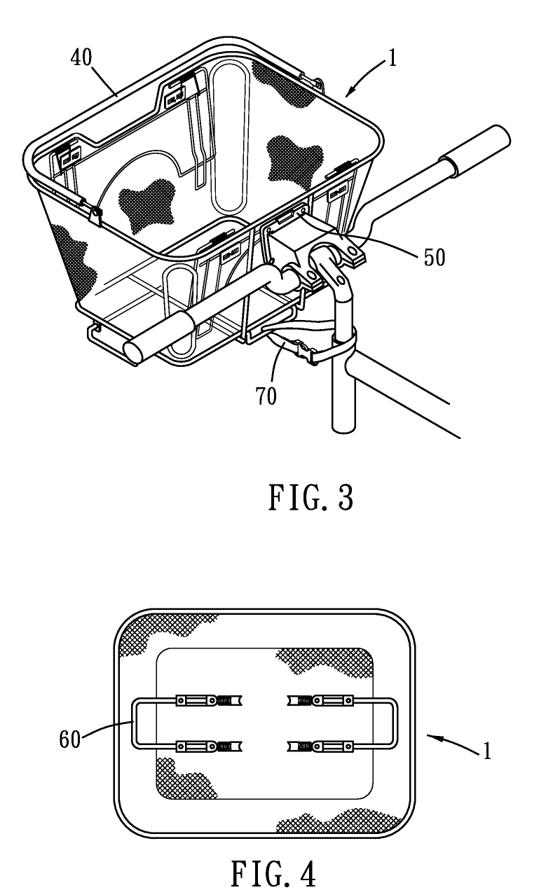

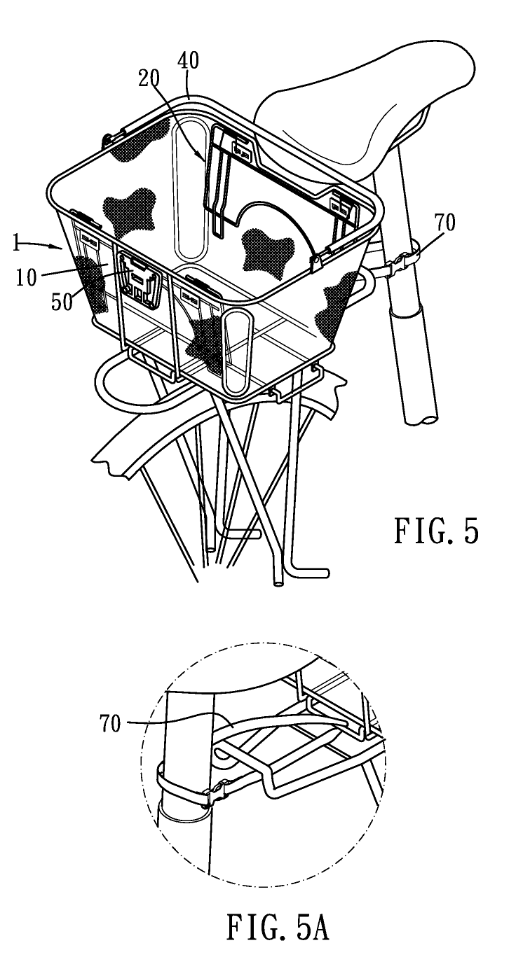

Please refer to FIG. 3. A handle 40 can be installed on the basket body 10. In addition, a quick-release clamp 50, functioning as a connecting member and being used for detachably connecting to a front of a handle of the bicycle, can be installed on an outer surface of the side of the basket body 10. Therefore, the basket 1 can be ported by a bicycle, while it can also function as a shopping carrier when detached from the bicycle. Now please refer to FIG. 4 and FIG. 5. A connecting base 60 can be installed on an outer surface of the bottom of the basket body 10, and it is used for detachably connecting to a luggage carrier of the bicycle, which is also a considerate design for the users.

Please refer to FIG. 5A. On the basket body 10 further disposes a fasten belt 70 to be hitched on a seat tube, a luggage carrier or a stem of a bicycle, which can presenting the basket 1 from shaking when the basket 1 is ported by the bicycle.

In the present invention, the wings 20 can be made of frames or plates to cover the opening. In addition, the basket body 10 can be form in mesh, knit or plate structure to carry goods.

In summary, the basket of the present invention can provide sufficient coverage of protection, and two wings thereof can connect to each other by simple fastening means. Furthermore, due to the simplicity the basket is, the production cost is reduced and it is much more convenient than conventional ones for the users to utilize.

What is claimed is:

1. A basket, comprising:
a basket body with an upper opening, the basket body defining an inner space therein; and
two wings, pivoted on two opposite sides of the basket body respectively and being able to wiggle with respect to the sides, wherein a length between a fixed end and a free end of each of said wings is smaller than a height of the basket body, and a sum of said lengths is a little larger than a breadth of the opening, on the free ends of the wings are disposed fasten members corresponding to and being able to connect with each other, so that the two wings bridge the opening and cover the inner space, while the wings being drooping when the fasten members are not connecting with each other.

2. The basket according to claim 1, wherein the wings consists of a first wing and a second wing, the fasten member on a free end of the first wing includes at least one first rectangular frame, the fasten member on a free end of the second wing includes at least one second rectangular frame, wherein a breadth of the first rectangular frame is larger than that of the second rectangular frame, and the second rectangular frame is able to thrust through a hole defined by the first rectangular frame, so that the two wings bridge the opening.

3. The basket according to claim 1, further comprising a plurality of torsion springs disposed between the basket body and the wings respectively, wherein an end of each of the torsion springs abuts the basket body, and another end of each of the torsion springs abuts the selected wing, whereby urging the wings wiggle toward a bottom of the basket body.

4. The basket according to claim 2, further comprising a plurality of torsion springs disposed between the basket body and the wings respectively, wherein an end of each of the torsion springs abuts the basket body, and another end of each of the torsion springs abuts the selected wing, whereby urging the wings wiggle toward a bottom of the basket body.

5. The basket according to claim 1, further comprising a connecting member installed on the basket body for connecting the basket to a bicycle, wherein the connecting member includes a quick-release clamp installed on an outer surface of the side of the basket body, and the quick release clamp is for detachably connecting to a front of a handle of the bicycle.

6. The basket according to claim 1, further comprising a connecting member installed on the basket body for connecting the basket to a bicycle, wherein the connecting member includes a connecting base installed on an outer surface of a bottom of the basket body, and the connecting base is for detachably connecting to a luggage carrier of the bicycle.

7. The basket according to claim 1, wherein the free ends of the wings are formed in an arc shape, and the free ends of both wings define a circular hole when the connecting members connect with each other.

8. The basket according to claim 2, wherein the free ends of the wings are formed in an arc shape, and the free ends of both wings define a circular hole when the connecting members connect with each other.
